(19) United States
(12) Patent Application Publication
(10) Pub. No.: US 2011/0115309 A1
(43) Pub. Date: May 19, 2011

(54) METHOD OF SIZING, SELECTION AND COMPARISON OF ELECTRICAL MACHINES

(76) Inventor: Alexei Stadnik, Pittsburgh, PA (US)

(21) Appl. No.: 12/941,902

(22) Filed: Nov. 8, 2010

Related U.S. Application Data
(60) Provisional application No. 61/281,175, filed on Nov. 14, 2009.

(51) Int. Cl. H02K 41/02; H02K 1/00

(52) U.S. Cl. 310/12.01; 310/40 R

(57) ABSTRACT

The object of invention is the method of sizing, selection and comparison of linear and rotary electrical machines. According to the invention, the machines can be sized, selected and compared by new specific parameters: electromagnetic specific motor constant k_{EMS}, specific motor constant k_{S}, electromagnetic normal motor constant k_{EMN}, normal motor constant k_{N}, electromagnetic specific volume motor constant k_{EMSV}, specific volume motor constant k_{SV}, electromagnetic specific mass motor constant k_{EMSM} specific mass motor constant k_{SM} and relative continuous force F_{RC}. These parameters slightly depend on machine overall dimensions but mostly depend on machine design.

I, Alexei Stadnik, claim priority of provisional application No. 61/281,175

### BACKGROUND OF THE INVENTION

For sizing the electrical machines the parameter called “motor constant” is widely used (see, for example, “A Practical Use Of The Motor Constant c” by George A. Beauchemin—Motion Control, Jul. 25, 2009; “How to speed up dc motor selection”—Machine Design, Oct. 5, 2000; “Snake-oil specs spell trouble for motor sizing” by William A. Flesher—Machine Design, Jun. 4, 1998). The methods of sizing base on motor constant which highly depends on electrical machine overall dimensions. Therefore, the choice of electrical machines depends on electrical machine envelope. For example, if overall dimensions of one electrical machine are less than another electrical machine, it will have smaller motor constant. However, small electrical machine may be much better design than larger one.

### SUMMARY OF THE INVENTION

The invention provides a method of sizing, selection and comparison of electrical machines. The invented method use the new parameters called electromagnetic specific motor constant k_{EMS}, specific motor constant k_{S}, electromagnetic normal motor constant k_{EMN}, normal motor constant k_{N}, electromagnetic specific volume motor constant k_{EMSV}, specific volume motor constant k_{SV}, electromagnetic specific mass motor constant k_{EMSM}, specific mass motor constant k_{SM} and relative continuous force F_{RC}. These parameters slightly depend on electrical machine overall dimensions but mostly depend on machine design. Therefore, comparing the electrical machines with different specific parameters shows the difference in machine design. The method used new specific parameters has next main advantages:

1. Comparison of electrical machines. For two or more electrical machines with different overall dimensions new specific parameters show the difference in electrical machine design. If new specific parameters of one electrical machine more than other it is mean that electrical machine have better design. It is very useful for comparison of different electrical machines from various sources.

2. Selection of electrical machines. Selection of the source for electrical machine very often is not easy because each source provides data with different overall dimensions. It is very useful for engineers to solve this problem using new specific parameters that show the goodness of machine design for different electrical machines. To select source of electrical machine with better design the engineers can select source with better new specific parameters.

3. Electrical machines sizing. Very often the required motor constant does not meet any existing electrical machine from various sources or electrical machine overall dimensions do not fit the required envelope. The estimation of new motor constant or overall dimensions can be done using new specific parameters.

### DESCRIPTION OF THE FIGURES

FIG. 1—is the partial case of slotless, brushless flat linear machine with three phase winding.

FIG. 2—is flat linear machine, forcer length less than magnet track length

FIG. 3—is flat linear machine, magnet track length less than forcer length

FIG. 4—is balanced linear machine

FIG. 5—is U-shape linear machine, forcer length less than magnet track length

FIG. 6—is U-shape linear machine, magnet track length less than forcer length

FIG. 7—is tube linear machine, forcer length less than magnet track length

FIG. 8—is tube linear machine, magnet track length less than forcer length

FIG. 9—is frameless rotary machine

FIG. 10—is housed rotary machine

### DESCRIPTION OF THE PREFERRED EMBODIMENT

The motor constant is defined as

$${k}_{M} = \frac{{F}_{C}}{\sqrt{P}} \qquad ( 1 )$$

Where F_{C} is continuous force produced by linear machine, P is continuous heat dissipation.

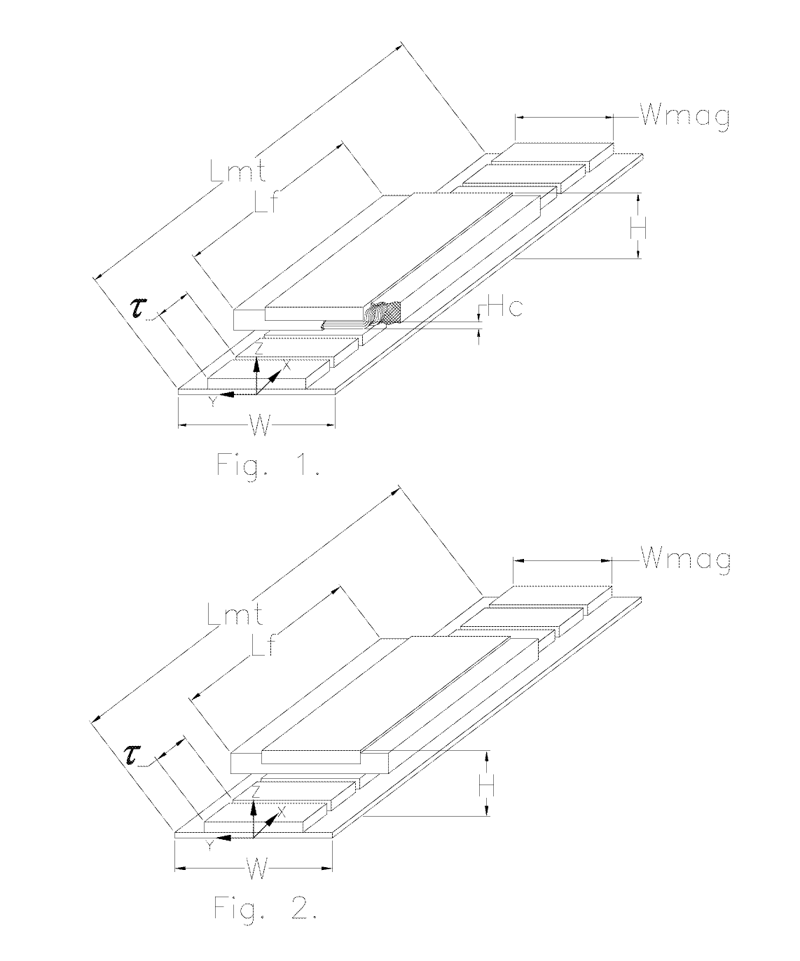

Consider the partial case of linear machine (FIG. 1). The machine is slotless, brushless and flat with three phase winding. The following assumptions have been made:
Number of slots per pole and phase is 1 (q=1).
Magnetic field has only components on X and Z axis B_{X} and B_{Z}: B_{Y}=0
There is no magnetic field outside of interval from −w_{mag}/2 to w_{mag}/2 along Y axis
The B_{Z} is sinusoidal along X axis
The B_{Z} along Z axis inside of coil is not changed
The commutation is sinusoidal
Forcer length is less than magnet track length

Taking into account the assumptions above, one can get the analytical equation for motor constant at 25° C.:

$${k}_{M} = \frac{3}{π} \frac{1}{\sqrt{2}} \cdot \frac{{B}_{MAX} \cdot \sqrt{{k}_{fil}} \cdot \sqrt{{k}_{Width}} \cdot \sqrt{{k}_{Height}}}{\sqrt{{ρ}_{25}} \cdot \sqrt{1 + {k}_{epw}}} \cdot \sqrt{W \cdot H \cdot τ \cdot {N}_{FPoles}} \qquad ( 2 )$$

where B_{MAX}—maximum value of magnetic field inside coil,

$${k}_{Width} = \frac{{w}_{mag}}{W} , \\ {w}_{mag}$$

—magnet width (see FIG. 1),

$${k}_{Height} = \frac{{h}_{c}}{H} ,$$

h_{c}—coil height (see FIG. 1), ρ₂₅—conductors specific resistivity at 25° C., N_{FPoles}—number of forcer poles, H and W—linear machine overall dimensions, τ—motor pole pitch (see FIG. 1). The parameter k_{fil} in (2) is coefficient of filling factor. By definition,

$${k}_{fil} = \frac{3 {N}_{0} \cdot {S}_{c}}{{h}_{c} \cdot τ} \qquad ( 3 )$$

where N₀ is number of coil turns per pole and phase, S_{C} is area of cross-section of conductor without insulation.

Another coefficient k_{epw} is called the coefficient of end parts and defined as

$${k}_{epw} = \frac{{l}_{turn} - 2 \cdot {w}_{mag}}{2 \cdot {w}_{mag}} \qquad ( 4 )$$

Here lₜᵤᵣₙ is length of one turn.

So, for slotless brushless flat linear electrical machine the following relation between motor dimensions and motor constant:

k_{M}˜\sqrt{N_{FPoles}·τ·W·H} (5)

k_{M}˜\sqrt{N_{FPoles}·V_{Pole}} (6)

where V_{Pole} is the volume of machine per pole pitch length.

### Linear Motors, Electromagnetic Specific Motor Constant

The specific parameter k_{EMS} is called “electromagnetic specific motor constant”. In contrast to motor constant, it does not depend on motor length, slightly depends on electrical machine dimension and reflects only the design of electrical machine. For electrical machines with forcer length less than magnet track length, electromagnetic specific motor constant is defined as

$${k}_{EMS} = \frac{{k}_{M}}{\sqrt{{N}_{FPoles} \cdot τ \cdot W \cdot H}} \qquad ( 7 )$$

where k_{M} is motor constant, N_{FPoles} is number of forcer poles, τ is motor pole pitch, H and W are linear machine overall dimensions.

For electrical machines with magnet track length less than forcer length,

$${k}_{EMS} = \frac{{k}_{M}}{{k}_{MT F poles} \cdot \sqrt{{N}_{FPoles} \cdot τ \cdot H \cdot W}} ,$$

where

$${k}_{MT \_ F \_ poles} = \frac{{N}_{MT Poles}}{{N}_{FPoles}} ,$$

N_{MTPoles} is number of magnet track poles.

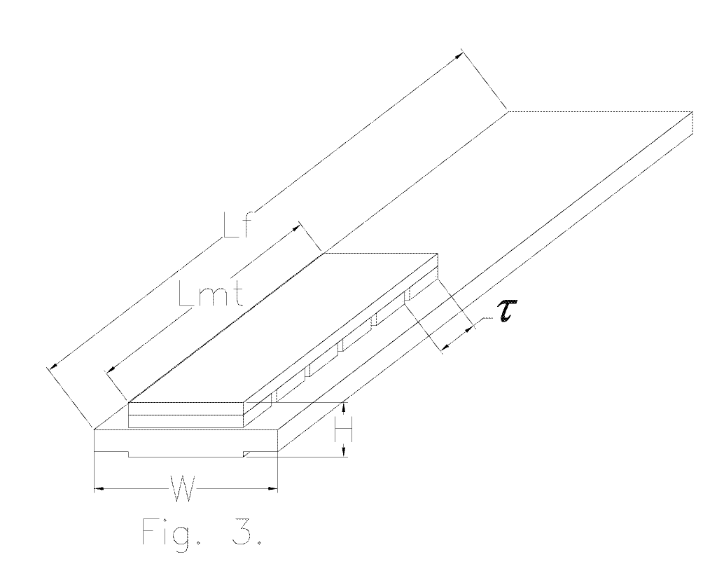

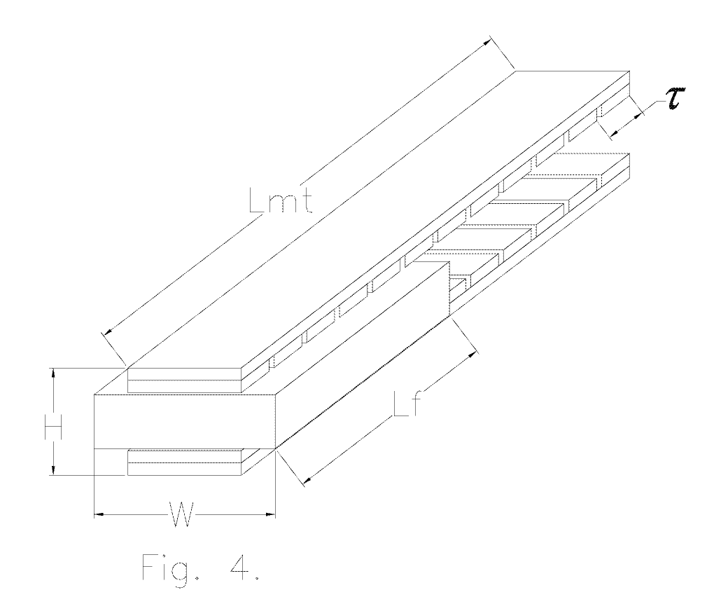

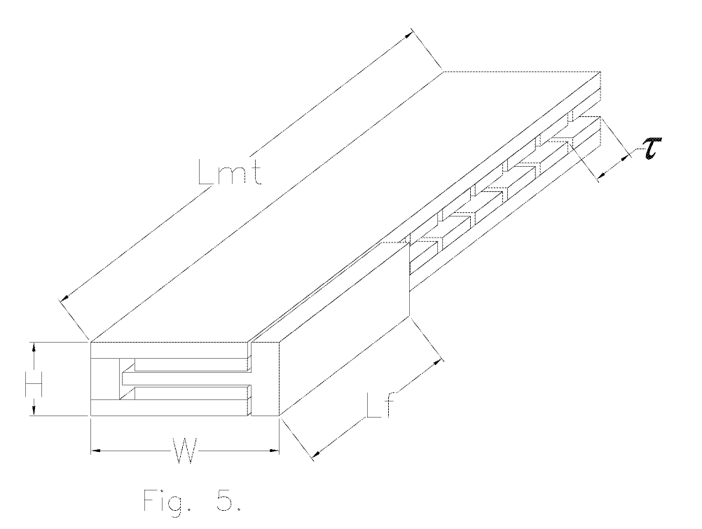

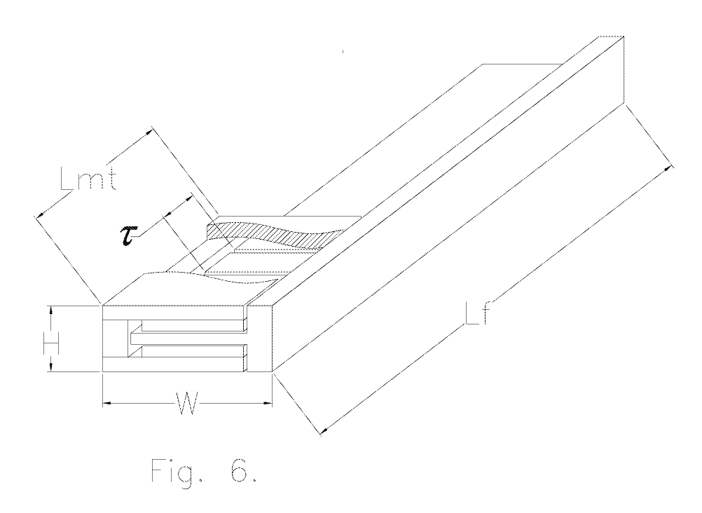

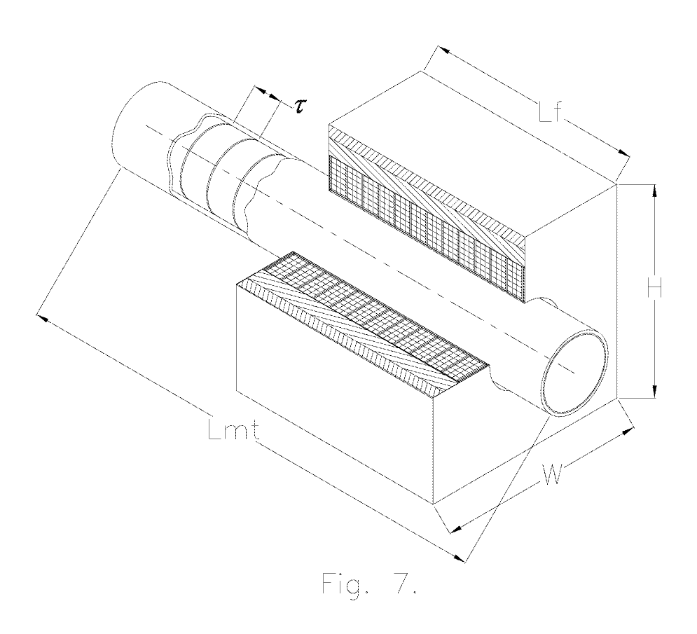

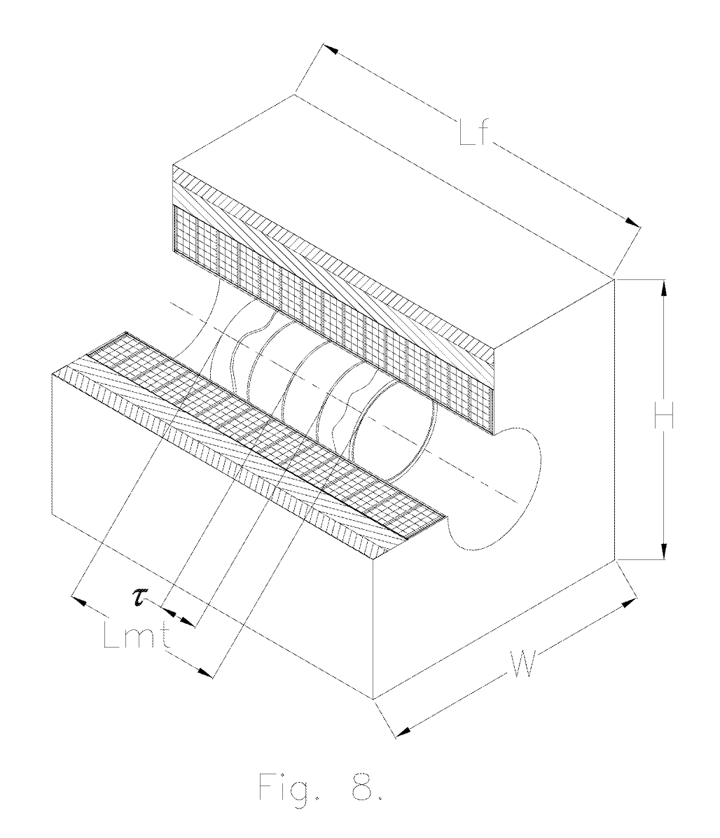

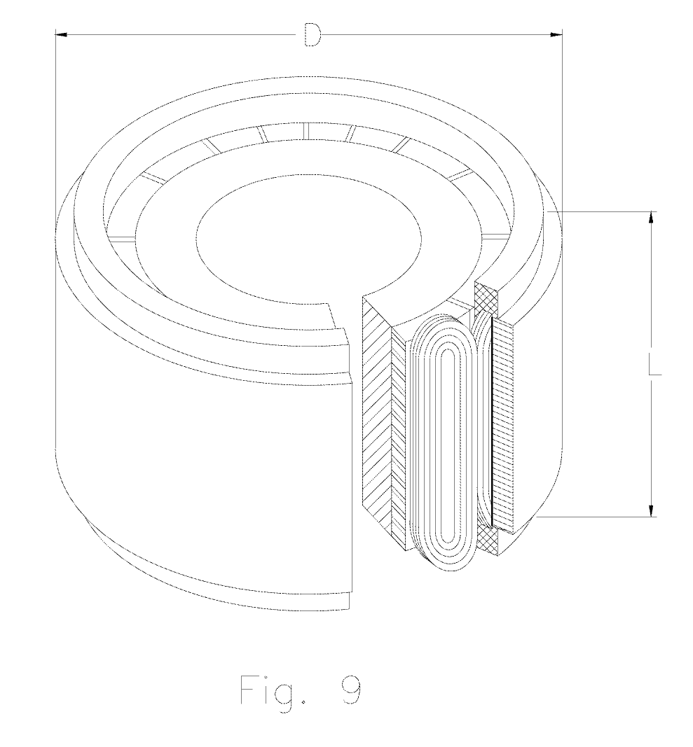

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Linear Motors, Specific Motor Constant

The specific parameter k_{S} is called “specific motor constant”. In contrast to motor constant, it slightly depends on machine dimension and reflects only the design of electrical machine. For electrical machines with forcer length less than magnet track length, specific motor constant is defined as

$${k}_{S} = \frac{{k}_{M}}{\sqrt{{L}_{F} \cdot W \cdot H}} \qquad ( 8 )$$

Here k_{M} is motor constant, L_{F} is forcer length, H and W are linear machine overall dimensions. For machines with magnet track length less than forcer length,

$${k}_{S} = \frac{{k}_{M}}{{k}_{MT \_ F \_ length} \cdot \sqrt{{L}_{F} \cdot W \cdot H}} , \qquad$$

where

$${k}_{MT \_ F \_ length} = \frac{{L}_{MT}}{{L}_{F}} ,$$

L_{MT} is magnet track length.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Linear Motors, Electromagnetic Normal Motor Constant

The specific parameter k_{EMN} is called “electromagnetic normal motor constant”. In contrast to motor constant, it does not depend on motor length. For electrical machines with forcer length less than magnet track length, electromagnetic normal motor constant is defined as

$${k}_{EMN} = \frac{{k}_{M}}{\sqrt{{N}_{FPoles} \cdot τ}} \qquad ( 9 )$$

where k_{M} is motor constant, N_{FPoles} is number of forcer poles, τ is motor pole pitch.

For electrical machines with magnet track length less than forcer length,

$${k}_{EMN} = \frac{{k}_{M}}{{k}_{MT \_ F \_ poles} \cdot \sqrt{{N}_{FPoles} \cdot τ}} ,$$

where

$${k}_{MT \_ F \_ poles} = \frac{{N}_{MT Poles}}{{N}_{FPoles}} ,$$

N_{MTPoles} is number of magnet track poles.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Linear Motors, Normal Motor Constant

The specific parameter k_{N} is called “normal motor constant”. In contrast to motor constant, it slightly depends on forcer length. For electrical machines with forcer length less than magnet track length, normal motor constant is defined as

$${k}_{N} = \frac{{k}_{M}}{\sqrt{{L}_{F}}} . \qquad ( 10 )$$

Here k_{M} is motor constant, L_{F} is forcer length. For machines with magnet track length less than forcer length,

$${k}_{N} = \frac{{k}_{M}}{{k}_{MT \_ F \_ length} \cdot \sqrt{{L}_{F}}} ,$$

where

$${k}_{MT \_ F \_ length} = \frac{{L}_{MT}}{{L}_{F}} ,$$

L_{MT} is magnet track length.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

Linear Motors, Electromagnetic specific volume motor constant

The specific parameter k_{EMSV} is called “electromagnetic specific volume motor constant”. For electrical machines with forcer length less than magnet track length, electromagnetic specific volume motor constant is defined as

$${k}_{EMSV} = \frac{{k}_{M}}{\sqrt{{N}_{FPoles} \cdot {V}_{Pole}}} \qquad ( 11 )$$

where k_{M} is motor constant, N_{FPoles} is number of forcer poles, V_{Pole} is volume of machine per pole pitch length. For machines with magnet track length less than forcer length,

$${k}_{EMSV} = \frac{{k}_{M}}{{k}_{MT \_ F \_ poles} \cdot \sqrt{{N}_{FPoles} \cdot {V}_{Pole}}} ,$$

where

$${k}_{MT \_ F \_ poles} = \frac{{N}_{MT Poles}}{{N}_{FPoles}} ,$$

N_{MTPoles} is number of magnet track poles.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Linear Motors, Specific Volume Motor Constant

The specific parameter k_{SV} is called “specific volume motor constant”. For electrical machines with forcer length less than magnet track length, specific volume motor constant is defined as

$${k}_{SV} = \frac{{k}_{M}}{\sqrt{{V}_{SF}}} \qquad ( 12 )$$

where k_{M} is motor constant, V_{SF} is volume of machine reduced to forcer length. For machines with magnet track length less than forcer length,

$${k}_{SV} = \frac{{k}_{M}}{\sqrt{{k}_{MT \_ F \_ length} \cdot {V}_{SMT}}} ,$$

where

$${k}_{MT \_ F \_ length} = \frac{{L}_{MT}}{{L}_{F}} ,$$

L_{MT} is magnet track length, L_{F} is forcer length, V_{SMT} is volume of machine reduced to magnet track length.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Linear Motors, Electromagnetic Specific Mass Motor Constant

The specific parameter k_{EMSV} called “electromagnetic specific mass motor constant”. For electrical machines with forcer length less than magnet track length, electromagnetic specific mass motor constant is defined as

$${k}_{EMSM} = \frac{{k}_{M}}{\sqrt{{N}_{FPoles} \cdot {M}_{Pole}}} \qquad ( 13 )$$

where k_{M} is motor constant, N_{FPoles} is number of forcer poles, M_{Pole} is machine mass per pole pitch length. For machines with magnet track length less than forcer length,

$${k}_{EMSM} = \frac{{k}_{M}}{{k}_{MT\_F \_poles} \cdot \sqrt{{N}_{FPoles} \cdot {M}_{Pole}}} ,$$

where

$${k}_{MT\_F \_poles} = \frac{{N}_{MTPoles}}{{N}_{FPoles}} ,$$

N_{MTPole} is number of magnet track poles.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Linear Motors, Specific Mass Motor Constant

The specific parameter k_{SM} is called “specific mass motor constant”. For electrical machines with forcer length less than magnet track length, specific mass motor constant is defined as

$${k}_{SM} = \frac{{k}_{M}}{\sqrt{{M}_{SF}}} \qquad ( 14 )$$

where k_{M} is motor constant, M_{SF} is machine mass reduced to forcer length. For machines with magnet track length less than forcer length,

$${k}_{SM} = \frac{{k}_{M}}{\sqrt{{k}_{MT\_F \_length} \cdot {M}_{SMT}}}$$

where

$${k}_{MT\_F \_length} = \frac{{L}_{MT}}{{L}_{F}} ,$$

L_{MT} is magnet track length, L_{F} is forcer length, M_{SMT} is machine mass reduced to magnet track length.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Linear Motors, Relative Continuous Force

For comparing the force characteristics of linear machines with different overall dimensions, the parameter F_{RC} called “relative continuous force” is introduced. For electrical machines with forcer length less than magnet track length, relative continuous force is defined as

$${F}_{RC} = \frac{{F}_{C}}{{L}_{F} \cdot W \cdot \sqrt{H}} \qquad ( 15 )$$

where F_{C} is continuous force produced by linear machine, L_{F} is forcer length, H and W are linear machine overall dimensions. For machines with magnet track length less than forcer length,

$${F}_{RC} = \frac{{F}_{C}}{{L}_{MT} \cdot W \cdot \sqrt{H}} ,$$

where L_{MT} is magnet track length.

Some examples of linear electrical machines are shown on FIG. 2 (flat linear machine, forcer length less than magnet track length); FIG. 3 (flat linear machine, magnet track length less than forcer length); FIG. 4 (balanced linear machine); FIG. 5 (U-shape linear machine, forcer length less than magnet track length); FIG. 6 (U-shape linear machine, magnet track length less than forcer length); FIG. 7 (tube linear machine, forcer length less than magnet track length) and FIG. 8 (tube linear machine, magnet track length less than forcer length).

### Rotary Motors, Specific Motor Constant

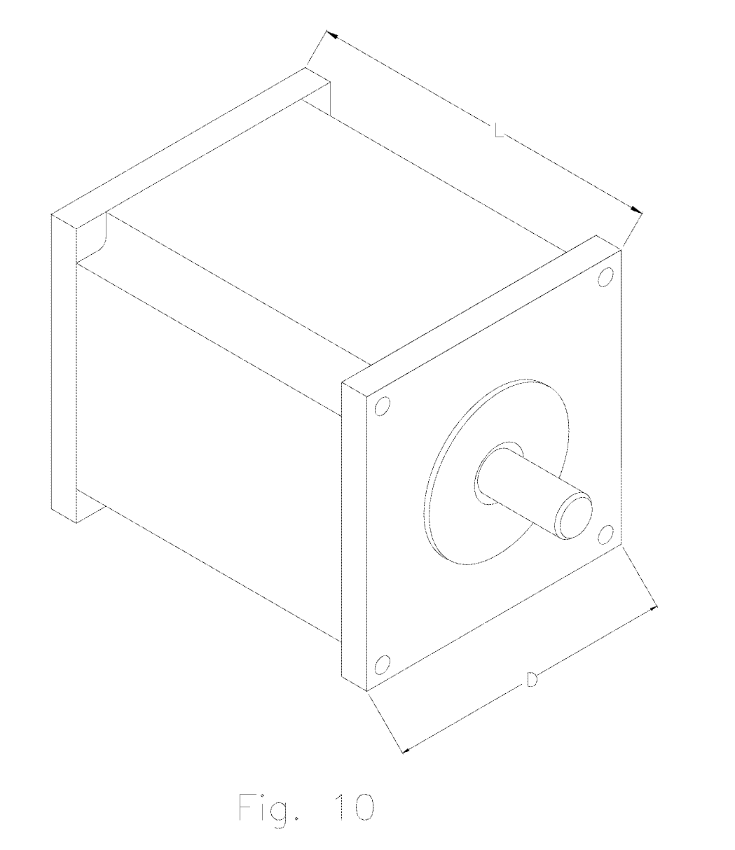

For rotary machines, the specific parameter called “specific motor constant” is introduced. It is defined as

$${k}_{S} = \frac{{k}_{M}}{D \cdot \sqrt{D \cdot L}} \qquad ( 16 )$$

where k_{M} is motor constant, L is length of rotary machine or length of winding of frameless rotary machine, D is outside diameter or dimension of square side of rotary machine. Some examples of rotary electrical machines are shown on FIG. 9 (frameless rotary machines) and FIG. 10 (housed rotary machines).

### Examples of Use

1. Linear motor, forcer is shorter than magnet track. The existing motor series is defined by height H, width W, different forcer lengths, poles numbers, and motor constants. We are going to keep existing cross-section and estimate k_{M}_{_{—}}_{new} for required poles number N_{FPoles}_{_{—}}_{req} or forcer length L_{F}_{_{—}}_{req} other than existed; or estimate poles number N_{FPoles}_{_{—}}_{new} or forcer length L_{F}_{_{—}}_{new} for required k_{M}_{_{—}}_{req} other than existed.

1.1. Estimation of motor constant k_{M}_{_{—}}_{new} for required poles number: N_{FPoles}_{_{—}}_{req}

Step 1—find electromagnetic specific motor constant k_{EMS}

Step 2—find

$${k}_{M\_new} = {k}_{EMS} \cdot \sqrt{{N}_{FPoles\_req} \cdot τ \cdot W \cdot H}$$

1.2. Estimation of poles number N_{FPoles}_{_{—}}_{new} for required motor constant: k_{M}_{_{—}}_{req}

Step 1—find electromagnetic specific motor constant k_{EMS}

Step 2—find

$${N}_{FPoles\_new} = Integer [ {( \frac{{k}_{M\_req}}{{k}_{EMS}} )}^{2} \cdot \frac{1}{τ \cdot W \cdot H} ] + 1$$

1.3. Estimation of motor constant k_{M new} for required forcer length: L_{F req}

Step 1—find specific motor constant k_{S}

Step 2—find

$${k}_{M\_new} = {k}_{S} \cdot \sqrt{{L}_{F\_req} \cdot W \cdot H}$$

1.4. Estimation of forcer length L_{F}_{_{—}}_{new} for required motor constant: k_{M}_{_{—}}_{req}

Step 1—find specific motor constant k_{S}

Step 2—find

$${L}_{F\_new} = {( \frac{{k}_{M\_req}}{{k}_{S}} )}^{2} \cdot \frac{1}{W \cdot H}$$

2. Linear motor, forcer is shorter than magnet track. The existing motors have different heights, widths, forcer lengths and motor constants. We are going to estimate k_{M}_{_{—}}_{new} for required overall dimensions L_{F}_{_{—}}_{req}, W_{req}, H_{req} other than existed; or estimate overall dimensions L_{F}_{_{—}}_{new}, W_{new}, H_{new} for required k_{M}_{_{—}}_{req} other than existed.

2.1. Estimation of motor constant k_{M}_{_{—}}_{new} for required overall dimensions L_{F}_{_{—}}_{req}, W_{req}, H_{req}.

Step 1—find specific motor constant k_{S}

Step 2—find

$${k}_{M\_new} = {k}_{S} \cdot \sqrt{{L}_{F\_req} \cdot {H}_{req} \cdot {W}_{req}}$$

2.2. Estimation of overall dimensions L_{F}_{_{—}}_{new}, W_{new}, H_{new} for required motor constant k_{M}_{_{—}}_{req}.

Step 1—find specific motor constant k_{S}

Step 2—find

$${L}_{F\_new} \cdot {W}_{new} \cdot {H}_{new} = {( \frac{{k}_{M\_req}}{{k}_{S}} )}^{2}$$

2. Linear motor, forcer is shorter than magnet track. The existing motors have different heights, widths, forcer lengths, continuous forces. We are going to estimate F_{C}_{_{—}}_{new} for required overall dimensions L_{F}_{_{—}}_{req}, W_{req}, H_{req} other than existed; or estimate overall dimensions L_{F}_{_{—}}_{new}, W_{new}, H_{new} for required F_{C}_{_{—}}_{req} other than existed.

2.1. Estimation of continuous force F_{C}_{_{—}}_{new} for required overall dimensions L_{F}_{_{—}}_{req}, W_{req}, H_{req}.

Step 1—find relative continuous force F_{RC}

Step 2—find

$${F}_{C \_ new} = {F}_{RC} \cdot {L}_{F \_ req} \cdot {W}_{req} \cdot \sqrt{{H}_{req}}$$

2.2. Estimation of overall dimensions L_{F}_{_{—}}_{new}, W_{new}, H_{new} for required continuous force F_{C}_{_{—}}_{req}

Step 1—find relative continuous force F_{RC}

Step 2—find

$${L}_{F \_ New} \cdot {W}_{new} \cdot \sqrt{{H}_{new}} = \frac{{F}_{C \_ req}}{{F}_{RC}}$$

3. Frameless radial rotary motors. The existing motors have different diameters, lengths and motor constants. We are going to estimate k_{M}_{_{—}}_{new} for required overall dimensions D_{req},L_{req}, other than existed; or estimate overall dimensions D_{new},L_{new} for required k_{M}_{_{—}}_{req} other than existed.

3.1. Estimation of motor constant k_{M}_{_{—}}_{new} for required overall dimensions D_{req},L_{req}.

Step 1—find specific motor constant k_{S}

Step 2—find

$${k}_{M \_ new} = {k}_{s} \cdot {D}_{req} \cdot \sqrt{{L}_{req} \cdot {D}_{req}}$$

3.2. Estimation of overall dimensions D_{new},L_{new} for required motor constant k_{M}_{_{—}}_{req}

Step 1—find specific motor constant k_{S}

Step 2—find

$${D}_{new} \cdot \sqrt{{L}_{new} \cdot {D}_{new}} = \frac{{k}_{M \_ req}}{{k}_{S}}$$

1. The electromagnetic specific motor constant for the linear machines with forcer length less than magnet track length
$${k}_{EMS} = \frac{{k}_{M}}{\sqrt{{N}_{FPoles} • τ • W • H}} ,$$
or for the linear machines with magnet track length less than forcer length
$${k}_{EMS} = \frac{{k}_{M}}{{k}_{MT \_ F \_ poles} • \sqrt{{N}_{F Poles} • τ • H • W}} ,$$
comprising motor constant k_{M}, number of forcer poles N_{FPoles}, pole pitch τ, motor height H, motor width W,
$${k}_{MT \_ F \_ poles} = \frac{{N}_{MTPoles}}{{N}_{FPoles}} ,$$
number of magnet track poles N_{MTPoles}, can be used for sizing, selection and comparison the linear machines.

2. The electromagnetic normal motor constant, comprising said electromagnetic specific motor constant, according to the claim 1, multiplied by \sqrt{W□H} (said motor height H, said motor width W),
$${k}_{EMN} = \frac{{k}_{M}}{\sqrt{{N}_{FPoles} • τ}}$$
(for the linear machines with forcer length less than magnet track length), or
$${k}_{EMN} = \frac{{k}_{M}}{{k}_{MT \_ F \_ poles} • \sqrt{{N}_{FPoles} •τ}}$$
(for the linear machines with magnet track length less than forcer length), comprising said motor constant k_{M}, said number of forcer poles N_{FPoles}, said pole pitch τ, said
$${k}_{MT \_ F \_ poles} = \frac{{N}_{MTPoles}}{{N}_{FPoles}} ,$$
said number of magnet track poles N_{MTPoles}, can be used for sizing, selection and comparison the linear machines.

3. The electromagnetic specific volume motor constant, comprising said electromagnetic specific motor constant, according to the claim 1, further comprising volume of machine per pole pitch length V_{Poles} instead of τ□W□H,
$${k}_{EMSV} = \frac{{k}_{M}}{\sqrt{{N}_{FPoles} • {V}_{Pole}}}$$
(for the linear machines with forcer length less than magnet track length), or
$${k}_{EMSV} = \frac{{k}_{M}}{{k}_{MT \_ F \_ poles} • \sqrt{{N}_{FPoles} • {V}_{Pole}}}$$
(for the linear machines with magnet track length less than forcer length), comprising said motor constant k_{M}, said number of forcer poles N_{FPoles}, said
$${k}_{MT \_ F \_ poles} = \frac{{N}_{MTPoles}}{{N}_{FPoles}} ,$$
said number of magnet track poles N_{MTPoles}, can be used for sizing, selection and comparison the linear machines.

4. The electromagnetic specific mass motor constant, comprising said electromagnetic specific motor constant, according to the claim 1, further comprising machine mass per pole pitch length M_{Pole} instead of τ□W□H,
$${k}_{EMSM} = \frac{{k}_{M}}{\sqrt{{N}_{FPoles} • {M}_{Pole}}}$$
(for the linear machines with forcer length less than magnet track length), or
$${k}_{EMSM} = \frac{{k}_{M}}{{k}_{MT \_ F \_ poles} • \sqrt{{N}_{FPoles} • {M}_{Pole}}}$$
(for the linear machines with magnet track length less than forcer length), comprising said motor constant k_{M}, said number of forcer poles N_{FPoles} said
$${k}_{MT\_F \_poles} = \frac{{N}_{MTPoles}}{{N}_{FPoles}} ,$$
said number of magnet track poles N_{MTPoles}, can be used for sizing, selection and comparison the linear machines.

5. The specific motor constant, comprising said electromagnetic specific motor constant, according to the claim 1, further comprising forcer length L_{F} instead of N_{FPoles}□τ,
$${k}_{S} = \frac{{k}_{M}}{\sqrt{{L}_{F} • W • H}}$$
(for the linear machines with forcer length less than magnet track length), or
$${k}_{S} = \frac{{k}_{M}}{{k}_{MT\_F \_length} • \sqrt{{L}_{F} • H • W}}$$
(for the linear machines with magnet track length less than forcer length), comprising said motor constant k_{M}, said motor height H, said motor width W,
$${k}_{MT\_F \_length} = \frac{{L}_{MT}}{{L}_{F}} ,$$
magnet track length L_{MT}, can be used for sizing, selection and comparison the linear machines.

6. The normal motor constant, comprising said electromagnetic specific motor constant, according to the claim 1, further comprising forcer length L_{F} instead of N_{FPoles}□τ□W□H,
$${k}_{N} = \frac{{k}_{M}}{\sqrt{{L}_{F}}}$$
(for the linear machines with forcer length less than magnet track length), or
$${k}_{N} = \frac{{k}_{M}}{{k}_{MT\_F \_length} • \sqrt{{L}_{F}}}$$
(for the linear machines with magnet track length less than forcer length), comprising said motor constant k_{M}, said
$${k}_{MT\_F \_length} = \frac{{L}_{MT}}{{L}_{F}} ,$$
said magnet track length L_{MT}, can be used for sizing, selection and comparison the linear machines.

7. The specific volume motor constant, comprising said electromagnetic specific motor constant, according to the claim 1, further comprising volume of machine reduced to forcer length V_{SF} instead of N_{FPoles}□τ□W□H,
$${k}_{SV} = \frac{{k}_{M}}{\sqrt{{V}_{SF}}}$$
(for the linear machines with forcer length less than magnet track length), or comprising volume of machine reduced to magnet track length V_{SMT} instead of N_{FPoles}□τ□W□H,
$${k}_{SV} = \frac{{k}_{M}}{\sqrt{{k}_{MT\_F \_length} • {V}_{SMT}}}$$
(for the linear machines with magnet track length less than forcer length), comprising said motor constant k_{M}, said forcer length L_{F}, said k_{MT}_{_{—}}_{F}_{_{—}}_{length}=L_{MT}/L_{F}, said magnet track length L_{MT}, can and be used for sizing, selection comparison the linear machines.

8. The specific mass motor constant, comprising said electromagnetic specific motor constant, according to the claim 1, further comprising machine mass reduced to forcer length M_{SF} instead of N_{FPoles}□τ□W□H,
$${k}_{SM} = \frac{{k}_{M}}{\sqrt{{M}_{SF}}}$$
(for the linear machines with forcer length less than magnet track length), or comprising machine mass reduced to magnet track length M_{SMT} instead of N_{FPoles}□τ□W□H,
$${k}_{SM} = \frac{{k}_{M}}{\sqrt{{k}_{MT\_F \_length} • {M}_{SMT}}}$$
(for the linear machines with magnet track length less than forcer length), comprising said motor constant k_{M}, said forcer length L_{F}, said
$${k}_{MT\_F \_length} = \frac{{L}_{MT}}{{L}_{F}} ,$$
said magnet track length L_{MT}, can be used for sizing, selection and comparison the linear machines.

9. The relative continuous force
$${F}_{RC} = \frac{{F}_{C}}{{L}_{F} • W • \sqrt{H}}$$
(for the linear machines with magnet track length less than forcer length), or
$${F}_{RC} = \frac{{F}_{C}}{{L}_{MT} • W • \sqrt{H}}$$
(for the linear machines with magnet track length less than forcer length), comprising continuous force F_{C}, said forcer length L_{F}, said magnet track length L_{MT}, said motor height H, said motor width W, can be used for sizing, selection and comparison the linear machines.

10. The specific motor constant
$${k}_{S} = \frac{{k}_{M}}{D • \sqrt{D • L}}$$
comprising motor constant k_{M}, length of rotary machine or length of winding of frameless rotary machine L, outside diameter or dimension of square side of rotary machine D, can be used for sizing, selection and comparison the rotary machines.

11. (canceled)

12. (canceled)

13. (canceled)

14. (canceled)

15. (canceled)

16. (canceled)

17. (canceled)

18. (canceled)

19. (canceled)
